(19) United States
(12) Patent Application Publication
(10) Pub. No.: US 2011/0061641 A1
(43) Pub. Date: Mar. 17, 2011

(54) Charcoal fuel assembly

(76) Inventor: Annie Chang, Arcadia, CA (US)

(21) Appl. No.: 11/802,584

(22) Filed: May 23, 2007

(51) Int. Cl. A47J 37/07

(52) U.S. Cl. 126/25 B

(57) ABSTRACT

A charcoal fuel assembly, especially a charcoal fuel packaging assembly that can be self ignited totally, is composed of a box, an interior of which is formed with a holding space which is divided into a holding part for emplacing the charcoal fuels and a bottom firing space by a pallet. The firing space is fixed with a fire precursor and is connected with an oxygen drain-in hole. The fire precursor first acts on the pallet and bottom charcoal fuels, which indirectly ignite the entire charcoal fuels that are loaded, to facilitate an ignition operation before carrying out cook-outs, and allow the charcoal fuels to be ignited approximately uniformly.

### BACKGROUND OF THE INVENTION

(a) Field of the Invention The present invention relates to a charcoal fuel assembly, and more particularly to an assembly which can totally ignite the charcoal fuels by itself before carrying out cook-outs, so as to facilitate preparation of cooking.

(b) Description of the Prior Art

As economic development, working population is concentrated in urban area. Therefore, citizens obviously eager for outdoor lives, and enjoy cook-outs at leisure time to feel a prospect of nature. Due to physical restrictions of journeys and energy, it is the safest to use charcoal fuel for the cook-outs. However, being restricted by an environmental factor and conventional equipment, it is difficult to start fire. Accordingly, the present inventor has already disclosed a packaging material which can assist with the ignition of the charcoal fuel, to provide innovated convenience.

### SUMMARY OF THE INVENTION

Accordingly, to reduce a manufacturing process and provide a user with clean portability, a combustible paper board is made into a box, with an interior of the box being provided with a holding part for emplacing charcoal fuel and a firing space for maintaining a fire precursor, which are divided by a combustible pallet. A lower end of the box is provided with an oxygen drain-in opening, and an upper end of the box is provided with a leading hole which is used for guiding hot air or flames formed in an initial phase of ignition to push the raw and cold charcoal fuels inside the box, such that the a secondary ignition can be resulted to the charcoal fuels which are stacked at a top and periphery, after creating a thermal reaction at a central bottom of the fuel stack. The primary object of present invention is to provide a charcoal fuel assembly which enables most of the charcoal fuels to be approximately ignited in total.

A second object of the present invention is to provide a charcoal fuel assembly that each element of the assembly can be burnt out completely, and an organic fertilizer can be formed, after using the charcoal fuel assembly.

A third object of the present invention is to provide a charcoal fuel assembly that the assembly can be ignited automatically and totally in stages, only by igniting a fire precursor, thereby facilitating an operation of starting fire.

A fourth object of the present invention is to provide a charcoal fuel assembly wherein a box of which can completely enclose internal content such that even charcoal debris will not fall out, thereby facilitating carrying and preventing from getting dirty.

A fifth object of the present invention is to provide a charcoal fuel assembly where in a box of which can be made by a paper board or a corrugated paper board that is provided with strength to achieve a purpose of buffering, thereby preventing internal content of the box from being explicitly damaged when being impacted.

A sixth object of the present invention is to provide a charcoal fuel assembly wherein top and bottom surfaces of a box of which are parallel to each other, so as to facilitate stacking, displaying, and exhibiting.

A seventh object of the present invention is to provide a charcoal fuel assembly wherein a box of which is a square body, a cylindrical body, or a polygonal pillar, such that when the boxes are aligned on a plane, it is easy to make a matrix-like arrangement, thereby facilitating transportation and packaging, as well as achieving the aforementioned total ignition.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of an assembly of the present invention.

FIG. 2 shows a schematic view of internal structures of an assembly of the present invention.

FIG. 3 shows a schematic view of implementing an ignition operation of the present invention.

FIG. 4 shows a working diagram of initial combustion in an ignition process of the present invention.

FIG. 5 shows a schematic view of a combustion process of the present invention.

FIG. 6 shows another schematic view of a combustion process of the present invention.

FIG. 7 shows still another schematic view of a combustion process of the present invention.

FIG. 8 shows a schematic view of the present invention which is positioned on a stove after being ignited totally.

FIG. 9 shows a structural diagram of making a box of the present invention.

FIG. 10 shows a schematic view of stabilizing a fire precursor at a bottom part of FIG. 9.

FIG. 11 shows a schematic view of an operation of taking out a fire precursor before using the present invention.

### DETAILED DESCRIPTION OF THE PREFERRED EMBODIMENTS

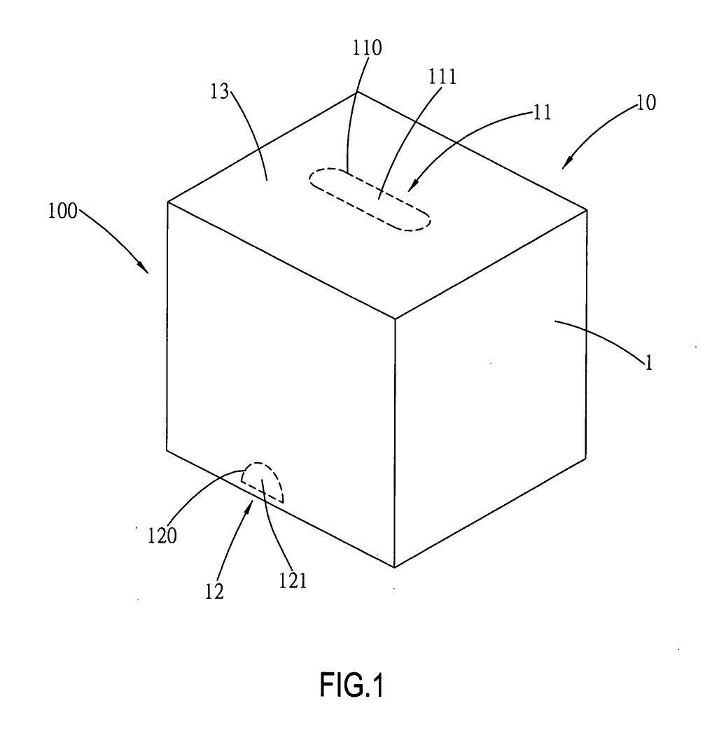

Referring to FIG. 1, a charcoal fuel assembly 10 of the present invention includes primarily a box 1 which is folded by a combustible board, such as a paper board or a corrugated paper board. An interior of the box 1 is formed with a holding space 100, a center of an upper lid 13 is provided with a leading hole 11 for guiding flames or hot air, and a bottom of the box 1 is provided with a drain-in hole 12 for supplying oxygen. The leading hole 11 and the oxygen drain-in hole 12 are sealed in advance, to prevent objects or debris inside the box 1 from being exposed. The sealing method can use precut outlines 110, 120 to surround into a shape of sealing plates 111, 121 which are opened by pricking or peeling before using, to configure the leading hole 11 and the drain-in hole 12.

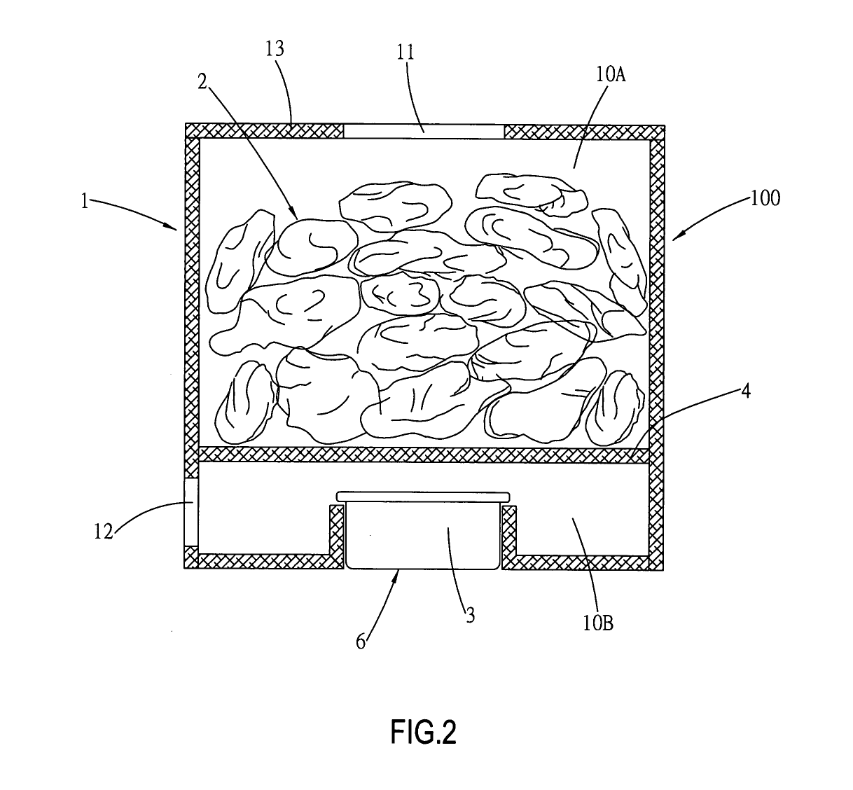

Referring to FIG. 2, the holding space 100 inside the box 1 can be divided into an upper holding part 10A and a lower firing space 10B by a combustible pallet 4. The upper lid 13 is provided with the leading hole 11 to connect with the holding part 10A, and the lower firing space 10B is connected with the oxygen drain-in hole 12, whereas a periphery is formed with a wind-proof configuration, to prevent a fire precursor 3 which is installed by a stabilizing member 6 from being affected by environmental air-flow. In addition, an interior of the holding part 10A is emplaced with charcoal fuels 2.

The aforementioned charcoal fuels are chunks of charcoal, and most of them are stacked in the holding part 10A. The charcoals are irregular chunks and are formed with the stack such that they can be aligned in the holding part 10A sufficiently. In order to standardize all the elements, the charcoal fuels can be formed by dense charcoals that are finished with wood fibers and are provided with a same shape. By having the same shape, the charcoal fuels can be orderly aligned in an emplacement space of the holding part 10A, which can sufficiently use the internal space of holding part 10A, and can form an explicit alignment as matrixes or layers to the standardized dense charcoals for making an angular orientation for receiving fire attack, particularly.

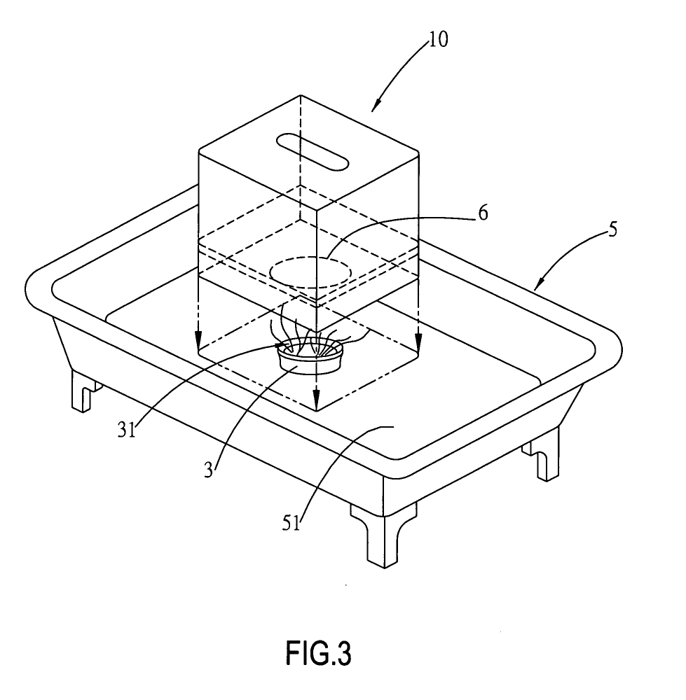

Referring to FIG. 3, in using the present invention, the fire precursor 3 is first taken out to emplace on a stove plate 51 of a stove 5. Flames are resulted after igniting a center of flame 31 above the fire precursor 3. The fire precursor 3 is loaded at the stabilizing member 6 for the entire assembly 10, and then the fire precursor 3 will be located in the aforementioned firing space. At this time, a shape of the burning fire precursor 3 will not be restricted by the stabilizing member 6, as long as that the flames of fire precursor 3 can attack to the aforementioned pallet or the charcoal fuels.

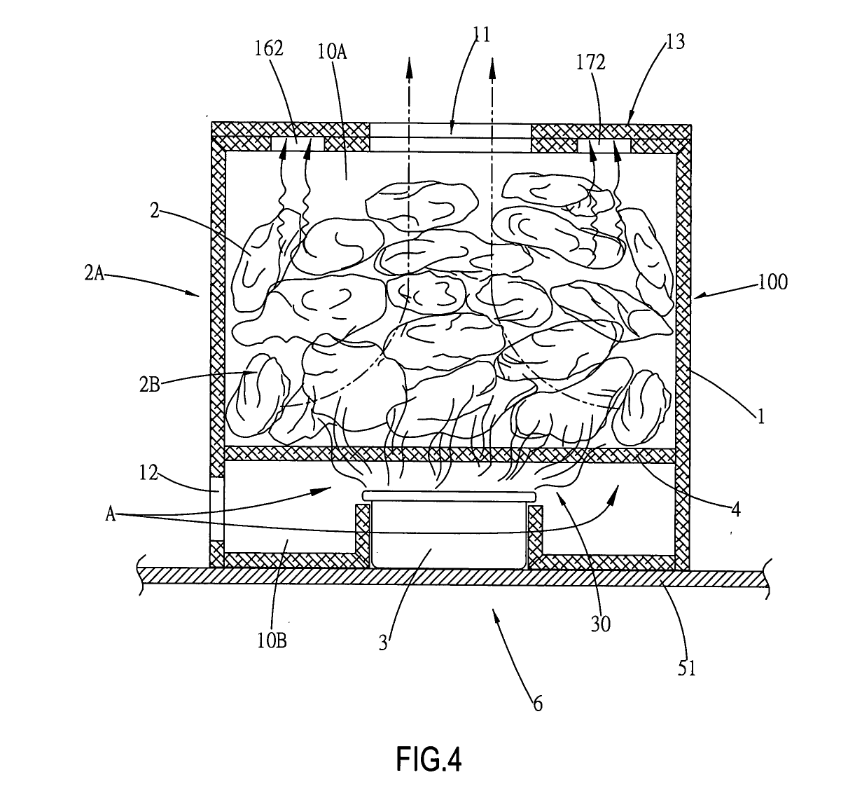

Referring to FIG. 4, after the aforementioned installation, the fire precursor 3 will be positioned at the stabilizing member 6 and will be located in an interior of the firing space 10B. Flames 30 which result will first attack to the combustible pallet 4 which will be burning by itself in advance, after receiving heat from the flames 30. Thermal power of burning the pallet 4 by itself acts on the charcoal fuels 2 above it to start fire which first acts on the lower charcoal fuels 2B. When the bottom charcoal fuels 2B reach to a state of self-combustion, heat is indirectly transmitted to the upper charcoal fuels 2A, and a total ignition is formed indirectly. The fire precursor 3 is configured as a regular solid body, such as a packaged fire pot or solid alcohol. In principle, its shape is positioned and supported by the stabilizing member 6 that it can be positioned in a center of the firing space 10B and form burning height of the flames 30 with a bottom surface of the pallet 4.

Upon igniting the fire precursor 3, air A which is needed is fed in from the drain-in hole 12 that is disposed as at least one hole. Other three sides of the box are used to fix and maintain the fire precursor 3, so as to prevent combustion of the fire precursor 3 from being directly affected by exterior air-flow.

Hot air which results in burning will flow upward t and be guided by the leading hole 11 of the upper lid 13; it will be accumulated at a center to float upward. The upper charcoal fuels 2A or the central parts will receive the heat of the hot air to form a pre-heating operation; therefore, they are easier to be ignited than other peripheral charcoal fuels. Accordingly, the entire heat energy will be concentrated at the center of the holding part 10A, and by three-dimensional transmission of thermal radiation waves, heat waves will be transmitted out from the center of stacked charcoal fuels 2, thereby approximately achieving the total ignition.

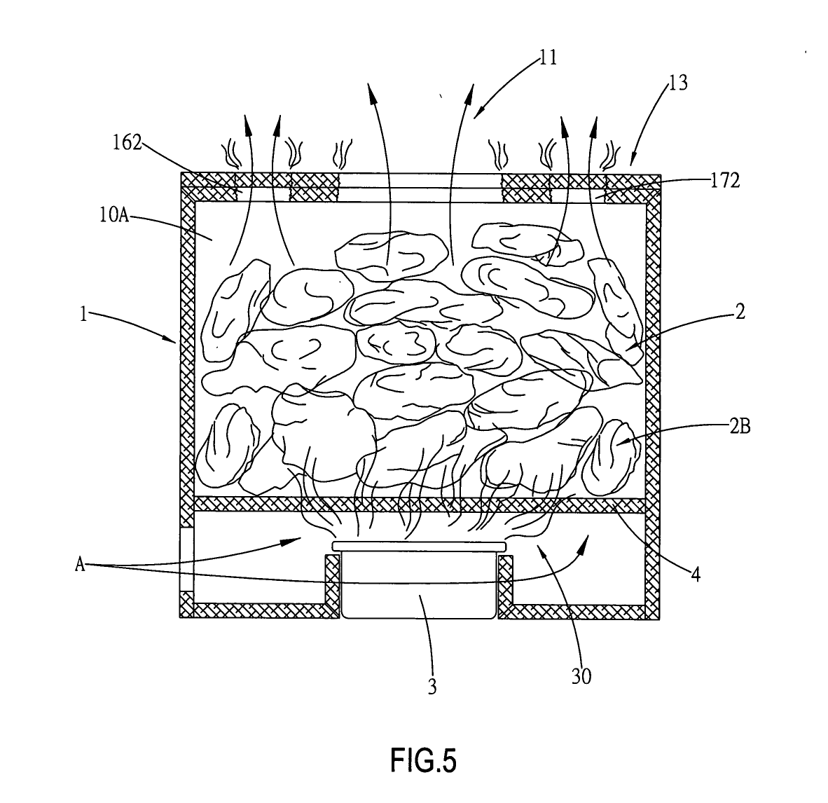

Referring to FIG. 5, after the flames 30 of fire precursor 3 have attacked to the pallet 4 to burn the lower charcoal fuels 2B, some part of the resulted hot air or flames is led out through the leading hole 11, and other part is pushed upward to transmit spatial thermal radiation in the interior of the holding part 10A, and to mix on an internal surface of the box 1. Therefore, the hot air will flow upward to be accumulated at the upper end of the holding part 10A, and will ignite a rim of the leading hole 11 first, thereby burning and fracturing the upper lid 13.

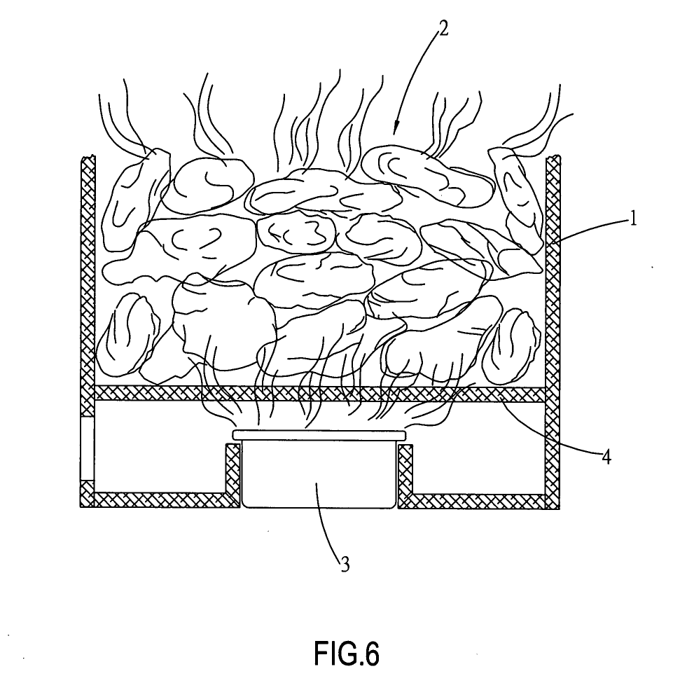

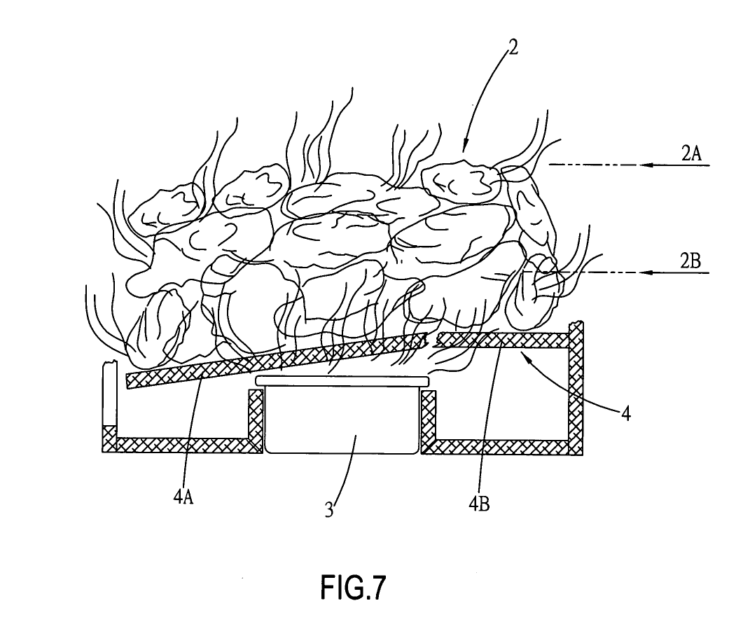

Referring to FIG. 6 and FIG. 7, after the upper lid 13 (not shown in the drawings) is burnt out, burning power will form an open-to-sky shape, and the pallet 4 will be fractured into fragments 4A, 4B after burning for a long time, along with that the upper and lower charcoal fuels 2A, 2B are crashed down. Accordingly, the entire stacked charcoal fuels 2 can form an operation of mixing or rotation by kinetic energy of crashing, allowing each charcoal fuel to have an equal opportunity of receiving the heat waves alternately, to be ignited.

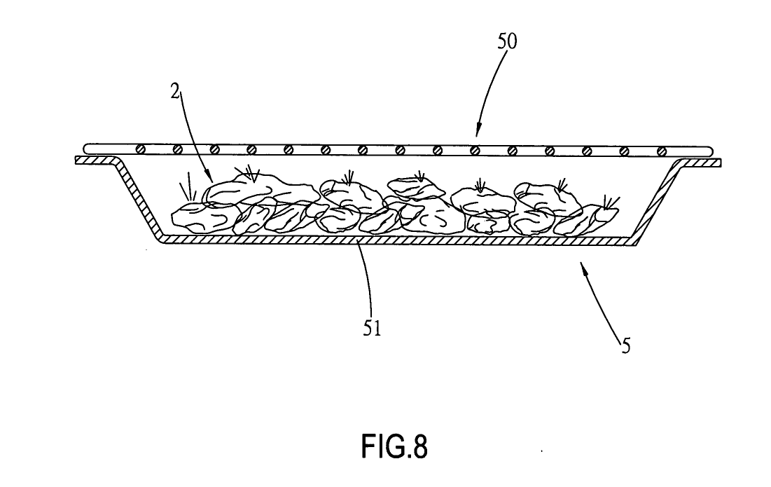

Referring to FIG. 8, the charcoal fuels 2 which are totally ignited as described above, are crashed down and distributed on an upper surface of the stove plate 51 of stove 5. If the distribution is not flat enough, any auxiliary tool can be used to separate and spread the charcoal fuels on the upper surface of the stove plate 51. In addition, due to the aforementioned ignition procedure, the charcoal fuels 2 can release thermal power in a self-combustion state approximately uniformly, to provide heat to food to be cooked or a pot on a mesh rack 50. As each particle of charcoal fuel achieves an equal state of self-combustion, it is not necessary to require the degree of self-combustion. Even a few of the particles does not achieve the self-combustion capability, they are mixed in the mostly self-combusted charcoal particles, and will be ignited very soon.

The assembly of present invention uses a box to enclose the internal charcoal fuels and to divide into the firing space for emplacing the fire precursor. Moreover, the oxygen drain-in hole and hot air leading hole which are connected to the exterior of the box are used to facilitate an operation of camp fire, such that as long as the fire precursor is ignited, the box can be left alone without caring to combust by itself. In the aforementioned procedure, after the hot air has first attacked to the pallet and the lower charcoal fuels, the central parts of the fuels are ignited in advance through the guiding of the leading hole, and then the thermal radiation waves which result from the ignition of the central parts are emitted to the peripheral charcoal fuel stacks, such that the charcoal fuels can approach to the total self-combustion. On the other hand, as the box is in a vertical shape, and its upper part is loaded with the charcoal fuels, the box will be crashed down by losing its structural intensity after burning out the pallet and the box. During the crashing process, the single charcoal fuel can be rotated by an angle and paved flat, such that the charcoal fuels can be effectively distributed on the upper end of the stove plate of the stove, thereby facilitating a user to ignite the raw and cold charcoal fuels.

The present invention is so convenient that even a kid who knows about fire safety can use it to easily ignite the raw and cold charcoal fuels, and the fuels will be turned into ashes and be mixed in earth after burning, which will be transformed into an organic fertilizer and be completely contained, thereby facilitating carrying cleanly, transporting, displaying, and exhibiting, which is a rather convenient innovated invention.

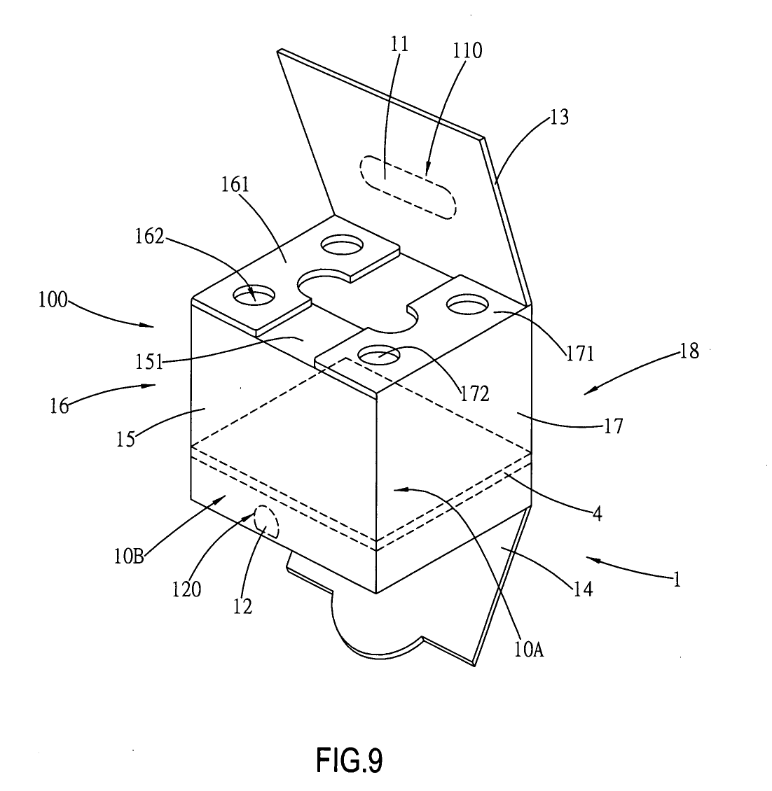

Referring to FIG. 9, the box 1 of the present invention is further formed by folding. Basically, the box 1 is in a three-dimensional square or rectangular shape, and is primarily provided with a three-dimensional holding space 100, such that after emplacing internal content, internal objects or debris will not fall out, in order to be suitable for manufacturing and transporting or to facilitate displaying, exhibiting, and accumulating.

The square box 1 is constituted by a front board 15, a left board 16, a right board 17, and a rear board 18, and its interior is emplaced with the pallet 4 for division.

The left board 16 at a top is extended upward with a left locking flop 161, the right board 17 is formed upward with a right locking flap 171, the front board 15 is formed with a front locking flap 151, and the rear board 18 is formed with an upper lid 13. Through alternately folding, the upper end of the box 1 is sealed. A center of the upper lid 13 is provided with a leading hole 11 which is formed by a precut outline 110 as described before, and a bottom of the box 1 is provided with a drain-in hole 12 which is connected to an internal firing space 10B. In addition, the drain-in hole 12 is also formed by a precut outline 120. The left and right locking flaps 161, 171 are provided with through-holes 162, 172 for connecting to the interior of the holding part 10A. Referring to FIG. 4 and FIG. 5, the through-holes 162 allow the hot air which results from the ignition process of the interior charcoal fuels 2 to burn toward a corresponding inner surface of the upper lid 13, forming the through-holes of air-flow for burning open the upper lid 13 in two stages, as shown in FIG. 5. In addition to that the leading hole 11 of upper lid 13 can guide out the air flow, the hot air flow can be even conducted orderly at the positions of through-holes 162, 172. By the actions of through-holes 162, 172, the hot air will be drawn to an edge at an upper end of the holding part 10A. Therefore, in addition to that the center of charcoal fuels is heated; the hot air will be also transmitted to the peripheral charcoal fuels.

Accordingly, the installation of through-holes 162, 172 allows the leading hole 11 to guide the hot air flow in an order from front to rear, which ignites the complete internal charcoal fuels in two stages. The leading hole 11 is primarily used for concentrating the thermal power of fire precursor, such that the thermal power can be accumulated directly to attack to the internal charcoal fuels and to meet requirement of internal heat convection.

The aforementioned upper lid 13 and a bottom of the box are all smooth and parallel, which facilitates overlapping or displaying. The box 1 is made by the combustible paper board or corrugated paper board, is deformable, and is provided with a buffering effect upon being subjected to impact of external force, to reduce a chance that the internal charcoal fuels are directly hit.

Below the box 1 is provided with a bottom lid 14.

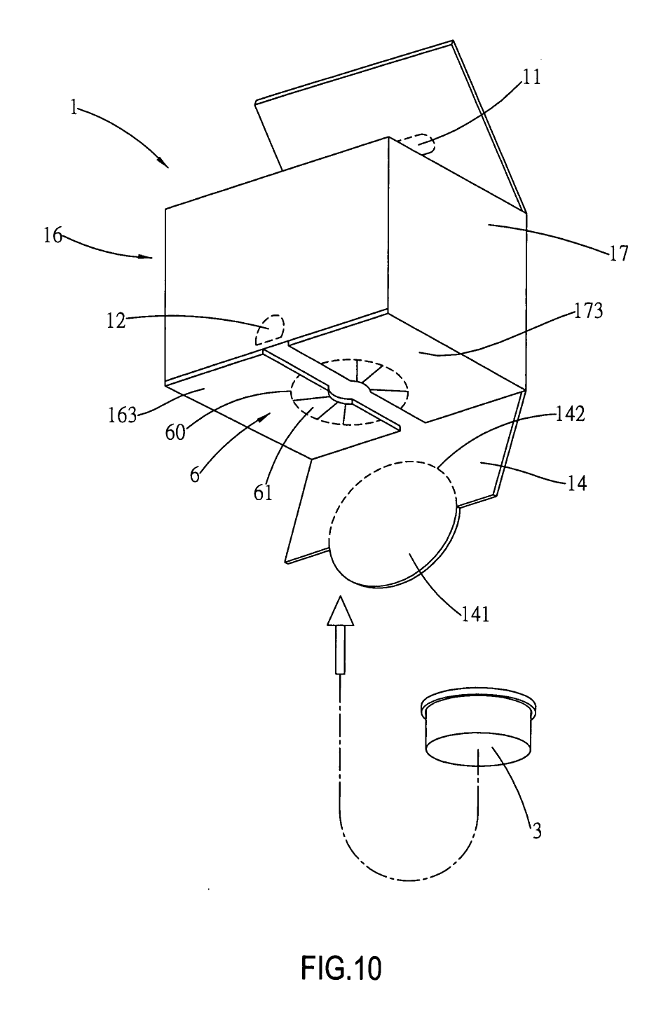

Referring to FIG. 10, the fire precursor 3 is fixed by a stabilizing member 6 which is formed by folding toward each other the left locking flap 163 and the right locking flap 173 that are located respectively below the left board 16 and the right board 17. A center of the stabilizing member 6 is formed with a virtual frame 60 which is cut into independent pieces by a plurality of division braids 61, with a root part at one side of which being connected with the left or right board 16, 17. An outline of the fire precursor 3 is similar to but smaller than the frame 60, and therefore can be stuffed into the stabilizing member 6 by pressure. In addition, the bottom lid 14 is used to cover and seal, which forms a package for shipping. The shipping package also includes the charcoal fuels and the pallet (as shown in FIG. 4).

The bottom lid 14 is provided with a maintenance board 141 corresponding to the fire precursor 3, so as to prevent the fire precursor 3 from being fallen out during transportation. Furthermore, after folding the aforementioned locking flaps, the box 1 can be packaged by any sealing method, to prohibit the internal content of the box 1 from being fallen out.

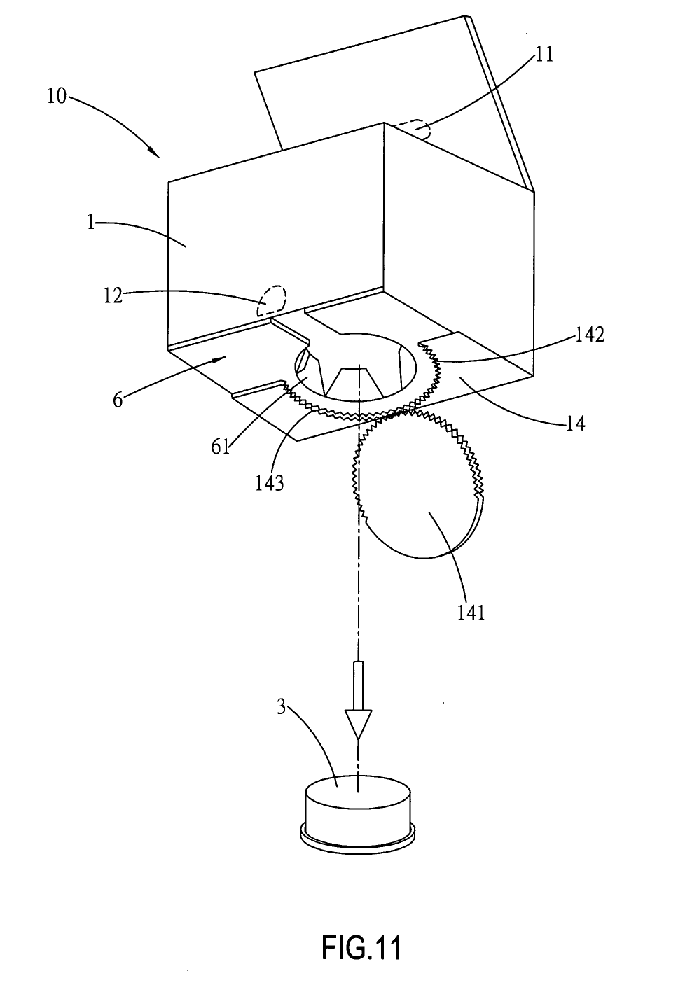

Referring to FIG. 11, as the prevent invention uses the box 1 for packaging, the board 141 which is installed on the bottom lid 14 should be opened to take out the fire precursor 3 before igniting, such that the fire precursor 3 can be ignited as shown in FIG. 3.

Similarly, to open the board 141, the board 141 is peeled off along a precut line 142, allowing the board 141 to be separated following a tear line 143. As for the drain-in hole 12 and the leading hole 11, they are opened as described before. Therefore, after igniting the fire precursor 3 as shown in FIG. 3, the same ignition sequence as shown in FIGS. 4 to 8, is initiated to achieve preparation for cooking.

In addition to a direct method of using the precut lines, the aforementioned packaging method for sealing the fire precursor 3, the leading hole 11, and the drain-in hole 12, can also use a way of affixing with pieces of paper for sealing; whereas upon using the assembly, an access path is opened by pricking.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A charcoal fuel assembly, especially a charcoal fuel assembly which can be self ignited totally, comprising a box which is folded by a paper board, an upper lid of which is provided with a leading hole, and a bottom of which is provided with a drain-in hole; a combustible pallet which separates a holding space in an interior of the box into a holding part at top and a firing space at bottom; a set of charcoal fuels, which are contained in the holding part; and a fire precursor, which is positioned at a stabilizing member located in a center of the firing space.

2. The charcoal fuel assembly according to claim 1, wherein the leading hole and the drain-in hole are sealed in advance.

3. The charcoal fuel assembly according to claim 1, wherein a bottom of the stabilizing member is sealed by a board.

4. The charcoal fuel assembly according to claim 1, wherein the charcoal fuel is a dense charcoal of natural fiber with an equal shape, and is aligned in the holding part.

5. The charcoal fuel assembly according to claim 1, wherein the charcoal fuels are chunks of charcoal fuel with an irregular outline.

6. The charcoal fuel assembly according to claim 4, wherein the dense charcoal is paved flat at least by more than one layer.

7. The charcoal fuel assembly according to claim 1, wherein the fire precursor is solid and is provided with a regular outline, with an outer surface being sealed.

8. The charcoal fuel assembly according to claim 1, wherein the fire precursor is a packaged fire pot.

9. The charcoal fuel assembly according to claim 7, wherein the outer surface of the fire precursor is positioned and supported by the stabilizing member upon packaging.

10. The charcoal fuel assembly according to claim 8, wherein the outer surface of the fire precursor is positioned and supported by the stabilizing member upon packaging.

11. The charcoal fuel assembly according to claim 1, wherein the leading hole or the oxygen drain-in hole is surrounded by a precut outline.

12. The charcoal fuel assembly according to claim 11, wherein the box is folded by a paper board or a corrugated paper board.

13. The charcoal fuel assembly according to claim 1, wherein the box is formed by surrounding with a front board, a left board, a right board, and a rear board, and by folding toward each other an upper lid and a bottom lid, with a left and right locking flaps being extended upward and downward respectively from the left and right boards; an interior of the box being divided into a holding part and a firing space by a pallet, and a drain-in hole and a leading hole being connected to an exterior; the holding part being emplaced with the charcoal fuels, and a bottom of the firing space being provided with a stabilizing member for installing a fire precursor.

14. The charcoal fuel assembly according to claim 13, wherein the left and right locking flaps at a top are provided respectively with a through-hole.

15. The charcoal fuel assembly according to claim 13, wherein the stabilizing member is formed by folding toward each other the left and right locking flaps at a bottom to form a virtual frame; an inner breadth of the frame being provided with division braids, and the stabilizing member being sealed by the bottom lid in advance.

16. The charcoal fuel assembly according to claim 15, wherein the bottom lid is defined by a precut line in advance.

17. The charcoal fuel assembly according to claim 13, wherein the drain-in hole and the leading hole are defined by the precut outlines.

18. The charcoal fuel assembly according to claim 13, wherein the box is folded by a combustible paper board or corrugated paper board.

19. The charcoal fuel assembly according to claim 13, wherein the leading hole and the drain-in hole are sealed by paper.
